(19) United States
(12) Patent Application Publication
(10) Pub. No.: US 2010/0187215 A1
(43) Pub. Date: Jul. 29, 2010

(54) Energy saving stove water heater

(76) Inventor: Liyan Weng, New York, NY (US)

Correspondence Address: David and Raymond Patent Firm, 108 N. Ynez Avenue, Suite 128, Monterey Park, CA, 91754, US

(21) Appl. No.: 12/310,789

(22) PCT Filed: Jan. 29, 2008
(86) PCT No.: PCT/CN2008/000211

§ 371 Date: Mar. 5, 2009

(51) Int. Cl. F27D 11/00

(52) U.S. Cl. 219/441; 219/438

(57) ABSTRACT

An energy saving stove water heater for heating water with a cooking stove includes an inner tank body, an outer tank body, a top panel, and a bottom panel. The inner tank body and the outer tank body define a water chamber therebetween. The top panel and the bottom panel sealedly enclose the water chamber to form a water tank. The inner and outer tank bodies are provided with a channel extending through the chamber for disposing a fuel line of the cooking stove. The outer tank body has a water inlet and a water outlet. The energy saving stove water heater is an energy saving device that is capable of heating up water flowing through the water chamber by fully utilizing the excessive heat from the cooking stove such that there is no need to consume any other energy to have hot water.

### BACKGROUND OF THE PRESENT INVENTION

1. Field of Invention

This present invention relates to a water heater use in cooking stove, and more particularly to an energy saving stove water heater which is capable of heating up water by means of the cooking stove.

2. Description of Related Arts

The boundary wall of the stove cavity of conventional cooking stove used in family or restaurant is constructed with fireproof bricks. Such stove cavity structure of the traditional cooking stove can't efficiently utilize the excessive heat during operation. The fireproof bricks need to be replaced frequency after a period of use. Moreover, it is inconvenient to assemble and use.

### SUMMARY OF THE PRESENT INVENTION

An object of the present invention is to provide an energy saving stove water heater, which has a simple structure and is convenient for set up and use. Also, it can achieve the goal of reducing exhaust and saving energy.

Accordingly, in order to accomplish the above object, the present invention provides an energy saving stove water heater which is constructed by an outer tank body, an inner tank body, a top panel and a bottom panel. The inner tank body and the outer tank body define a sealed water chamber therebetween. The inner and outer tank bodies are provided with a channel extending through the water chamber for disposing the fuel line.

The energy saving stove water heater is capable of heating up water by fully utilizing the excessive heat from a cooking stove such that there is no need to consume any other energy to have hot water to save energy. In addition, the independent water heater has a compact structure that is easier for set up and usage.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an energy saving stove water heater according to a preferred embodiment of the present invention.

FIG. 2 is a sectional view of the energy saving stove water heater according to the above preferred embodiment of the present invention.

FIG. 3 is a sectional view of the energy saving stove water heater according to the second preferred embodiment of the present invention.

FIG. 4 is a sectional view of the energy saving stove water heater according to the third preferred embodiment of the present invention.

FIG. 5 is a sectional view of the energy saving stove water heater according to the fourth preferred embodiment of the present invention.

### DETAILED DESCRIPTION OF THE PREFERRED EMBODIMENT

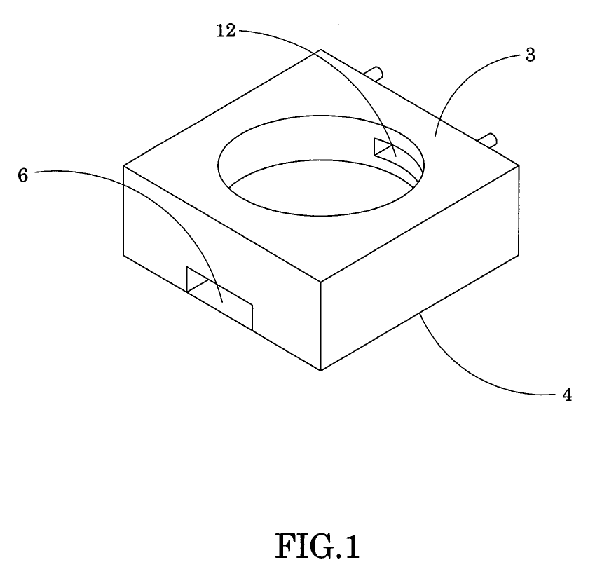

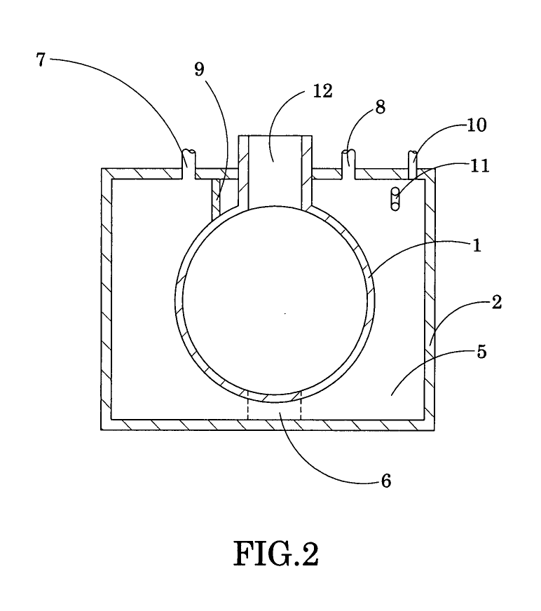

Referring to FIGS. 1 to 2 of the drawing, an energy saving stove water heater according to a preferred embodiment of the present invention is illustrated, which comprises a water tank communicatively equipped with a cooking stove. The energy saving stove water heater is constructed by an inner tank body 1, an outer tank body 2, a top panel 3, and a bottom panel 4. The inner tank body 1 and the outer tank body 2 define a ring-shape sealed water chamber 5 therebetween. The top panel 3 and the bottom panel 4 are connected on to a top side and a bottom side of the water chamber 5 respectively so as to sealedly enclose the water chamber 5 to form the water tank. The inner and outer tank bodies 1, 2 are provided with a channel 6 extending through the water chamber 5 for disposing the fuel line. The outer tank body 2 further has a water inlet 7 and a water outlet 8.

In order to prevent the incoming cool water from the water inlet 7 from immediately exiting at the water outlet 8, an isolated wall 9 is built between the water inlet 7 and the water outlet 8 in the water chamber 5 for separating incoming cool water and the exiting heated water within the water chamber 5.

For security and safety purpose, a safety valve 10 is installed to the outer tank body 2. The safety valve is communicated with the water chamber 5 for releasing the internal pressure and steam within the water chamber 5 while the water being heated up therein.

The energy saving stove water heater further comprises an electric heater 11 installed near the water outlet 8 within the water chamber 5 for generating electrical heat to heat up the water in the water chamber 5, wherein when the temperature of water is detected lower than the usage requirement, the electric heater 11 is switched to heat up the water to be exited through the water outlet 8 so as to ensure the temperature of the water supply from the stove water heater of the present invention.

As a reasonable design, the inner and outer tank bodies 1, 2 are provided with a ventilation channel 12 extending through the water chamber 5, wherein the ventilation channel 12 can be extended to the bottom panel 4 in a vertical direction to form a groove to make a detour with the exhaust line of the stove.

In view of above, a stove can be installed inside the cavity surrounded by the inner tank body 1 while the fuel pipe of the stove extends through the channel 6 and the exhaust line passes through the ventilation channel 12, not shown in Figures. In other words, the boundary bricks of the traditional stove are replaced by the stove water heater of the present invention as shown in FIGS. 1 to 8 to use the excessive heat generated from the stove to heat up the water flown in the water chamber 5 of the stove water heater of the present invention.

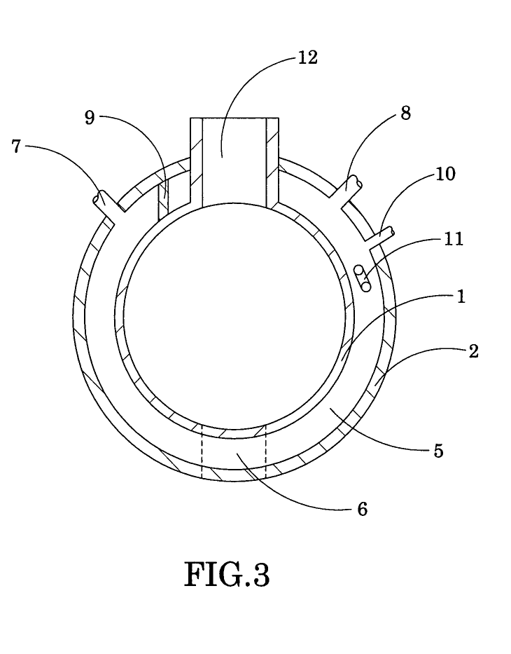

Referring to FIG. 3 of the drawing, a second preferred embodiment of the present invention is illustrated, wherein the difference between the second preferred embodiment and the above preferred embodiment is that the cross section of the outer tank body 2 is in circular shape instead of the rectangular shape as shown in FIGS. 1 to 2.

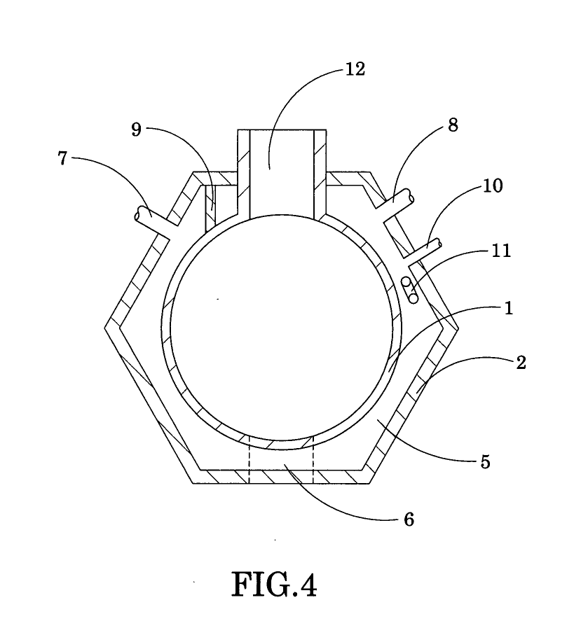

Referring to FIG. 4 of the drawing, a third preferred embodiment of the present invention is illustrated, wherein the difference between the third preferred embodiment and the above preferred embodiment is that the cross section of the inner tank body 2 in the third preferred embodiment is in hexagonal shape.

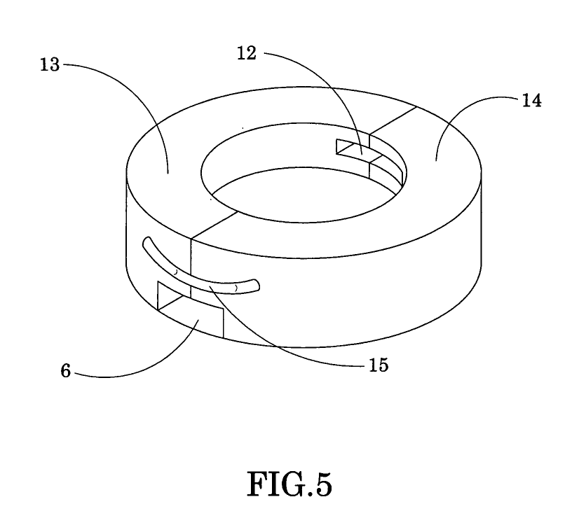

According to the fourth embodiment as shown in FIG. 5, the energy saving stove water heater of the present invention can be constructed by a left half body 13 and a right half body 14. The left half body 13 and the right half body 14 has a communicating tube 15 to connect with each other, wherein each of the left and right half body 13, 14 is provided with the water inlet 7 and the water outlet 8 respectively.

It is worth to mentioning that a cross section of the inner tank body 1 of the energy saving stove water heating is in circular shape.

In view of above, the energy saving stove water heater of the present invention is capable of heating up water flowing through the water chamber by fully utilizing the excessive heat from the cooking stove such that there is no need to consume any other energy to have hot water. Therefore, the energy saving stove water heater of the present invention is an energy saving device. In addition, the present invention is an individual and compact structure that is easier for assemble and usage.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1-11. (canceled)

12. A energy saving stove water heater for heating water with a cooking stove, comprising an inner tank body, an outer tank body, a top panel, and a bottom panel, said inner tank body and said outer tank body defining a water chamber therebetween, said top panel and said bottom panel sealedly enclosing said water chamber to form a water tank, said inner and outer tank bodies providing with a channel extending through said chamber for disposing a fuel line of the cooking stove, said outer tank body having a water inlet and a water outlet.

13. The energy saving stove water heater, as recited in claim 12, further comprising an isolated wall built between said water inlet and said water outlet in said water chamber for separating incoming cool water and exiting heated water within said water chamber.

14. The energy saving stove water heater, as recited in claim 12, further comprising a safety valve installed to said outer tank body to communicate with said water chamber for releasing internal pressure and steam within said water chamber whiling heating up water.

15. The energy saving stove water heater, as recited in claim 13, further comprising a safety valve installed to said outer tank body to communicate with said water chamber for releasing internal pressure and steam within said water chamber whiling heating up water.

16. The energy saving stove water heater, as recited in claim 12, further comprising an electric heater installed adjacent to said water outlet within said water chamber for generating electrical heat to heat up the water in said water chamber when a temperature of the water is lower than a usage requirement.

17. The energy saving stove water heater, as recited in claim 13, further comprising an electric heater installed adjacent to said water outlet within said water chamber for generating electrical heat to heat up the water in said water chamber when a temperature of the water is lower than a usage requirement.

18. The energy saving stove water heater, as recited in claim 14, further comprising an electric heater installed adjacent to said water outlet within said water chamber for generating electrical heat to heat up the water in said water chamber when a temperature of the water is lower than a usage requirement.

19. The energy saving stove water heater, as recited in claim 15, further comprising an electric heater installed adjacent to said water outlet within said water chamber for generating electrical heat to heat up the water in said water chamber when a temperature of the water is lower than a usage requirement.

20. The energy saving stove water heater, as recited in claim 12, wherein said inner and outer tank bodies are provided with a ventilation channel extending through said water chamber for forming a detour with exhaust line of the cooking stove.

21. The energy saving stove water heater, as recited in claim 13, wherein said inner and outer tank bodies are provided with a ventilation channel extending through said water chamber for forming a detour with exhaust line of the cooking stove.

22. The energy saving stove water heater, as recited in claim 14, wherein said inner and outer tank bodies are provided with a ventilation channel extending through said water chamber for forming a detour with exhaust line of the cooking stove.

23. The energy saving stove water heater, as recited in claim 15, wherein said inner and outer tank bodies are provided with a ventilation channel extending through said water chamber for forming a detour with exhaust line of the cooking stove.

24. The energy saving stove water heater, as recited in claim 16, wherein said inner and outer tank bodies are provided with a ventilation channel extending through said water chamber for forming a detour with exhaust line of the cooking stove.

25. The energy saving stove water heater, as recited in claim 17, wherein said inner and outer tank bodies are provided with a ventilation channel extending through said water chamber for forming a detour with exhaust line of the cooking stove.

26. The energy saving stove water heater, as recited in claim 18, wherein said inner and outer tank bodies are provided with a ventilation channel extending through said water chamber for forming a detour with exhaust line of the cooking stove.

27. The energy saving stove water heater, as recited in claim 19, wherein said inner and outer tank bodies are provided with a ventilation channel extending through said water chamber for forming a detour with exhaust line of the cooking stove.

28. The energy saving stove water heater, as recited in claim 12, wherein a cross section of said inner tank body is in circular shape and said outer tank body has a cross sectional shape selected from a group consisting of rectangular, circular, and hexagonal.

29. The energy saving stove water heater, as recited in claim 27, wherein a cross section of said inner tank body is in circular shape and said outer tank body has a cross sectional shape selected from a group consisting of rectangular, circular, and hexagonal.

30. The energy saving stove water heater, as recited in claim 12, wherein said water tank comprises a left half body and a right half body, wherein said left half body and said right half body has a communicating tube to connect with each other.

31. The energy saving stove water heater, as recited in claim 27, wherein said water tank comprises a left half body and a right half body, wherein said left half body and said right half body has a communicating tube to connect with each other.
